(19) United States
(12) Patent Application Publication
(10) Pub. No.: US 2018/0251390 A1
(43) Pub. Date: Sep. 6, 2018

(54) Systems and methods for treating cementitious article forming process water

(71) Applicant: James Hardie Technology Limited, Dublin 2 (IE)

(72) Inventors: Michael James Sullivan, Blue Jay, CA (US); Thomas Patrick Mueller, Yucaipa, CA (US); Lijun Mao, Rancho Cucamonga, CA (US); Samantha Lopez, Rancho Cucamonga, CA (US)

(21) Appl. No.: 15/932,364

(22) Filed: Feb. 16, 2018

Related U.S. Application Data
(60) Provisional application No. 62/460,662, filed on Feb. 17, 2017.

(51) Int. Cl. C02F 9/00; B28B 17/00

(52) U.S. Cl. CPC C02F 9/00; C02F 1/5245; B28B 17/00

(57) ABSTRACT

Systems and methods for treating spent process water containing sulfate and calcium ions. A treatment method includes adding sodium aluminate to a volume of the spent process water to form a solid precipitate containing aluminum, calcium, and sulfate compounds such as ettringite (Ca₆Al₂(SO₄)₃(OH)₁₂.26H₂O). The solid precipitate is removed from the process water by clarifying and/or filtration, yielding a disposable solid waste material and a treated process water having concentrations of sulfate and calcium ions significantly lower relative to the initial concentrations in the spent process water.

### CROSS-REFERENCE TO RELATED APPLICATIONS

This application claims the benefit of U.S. Provisional Application Ser. No. 62/460,662, filed Feb. 17, 2017, entitled “SYSTEMS AND METHODS FOR TREATING CEMENTITIOUS ARTICLE FORMING PROCESS WATER,” which is hereby incorporated by reference in its entirety and for all purposes.

### BACKGROUND

### Field

The present disclosure generally relates to manufacturing cementitious building products, and more specifically to systems and methods for treating process water used in manufacturing processes.

### Description of the Related Art

Manufacturing cementitious building articles, such as fiber cement products, typically requires the use of water as a process aid. During manufacturing, ions such as sulfate, calcium, sodium, and potassium can leach from the cement materials and build up in the process water. High concentrations of such ions in the process water can negatively affect the quality of the cementitious building products as well as the operation of machinery such as sheet machines and other associated manufacturing processes. Process water with high ion concentrations is typically recycled or discharged.

Discharge of spent process water with high ion concentrations can be limited by requirements of discharge permits or other regulations preventing process water from being freely discharged. In some cases, process water effluent may be required to conform to a maximum concentration of certain ion constituents, such as sulfates, before it can be discharged. Existing methods of reducing sulfate concentration in process water include ion exchange and precipitation with barium chloride solution, both of which can be undesirably expensive for reduction of sulfate concentration to acceptable levels. Accordingly, more efficient and/or affordable methods of ion removal from process water are desirable.

### SUMMARY

The systems, methods, and devices described herein address one or more problems as described above and associated with current process water treatment systems. The systems, methods and devices described herein have innovative aspects, no single one of which is indispensable or solely responsible for their desirable attributes. Without limiting the scope of the claims, the summary below describes some of the advantageous features.

In one embodiment, a method of treating process water from a cementitious article forming process is described. The method includes receiving the process water from the cementitious article forming process, the process water comprising at least sulfate ions and calcium ions in solution, reacting sodium aluminate with the sulfate ions and the calcium ions to form a solid precipitate primarily comprising ettringite, the solid precipitate suspended within the process water in slurry form; clarifying the slurry to produce a clarified process water and a sludge that includes the solid precipitate; and filtering the sludge to produce a liquid filtrate and a solid waste.

In some embodiments, the method further includes adjusting the pH of the liquid filtrate and the clarified process water, and releasing the liquid filtrate and the clarified process water as effluent.

In some embodiments, the process water has an initial concentration of sulfate ions, and the liquid filtrate and the clarified process water each have a concentration of sulfate ions lower than 50% of the initial concentration of sulfate ions.

In some embodiments, the solid precipitate includes ettringite and calcium sulfate.

In some embodiments, the method further includes adding a flocculant to the process water before clarifying the process water and suspended precipitate.

In some embodiments, the method further includes, prior to the reacting, removing a permeate portion of the process water by reverse osmosis to produce a concentrate portion of the process water, wherein the reacting comprises combining the sodium aluminate with the concentrate portion of the process water.

In some embodiments, the quantity of process water and the quantity of sodium aluminate solution arc mixed for a reaction period of less than 20 minutes before the clarifying step.

In some embodiments, the sodium aluminate is not a limiting reagent of the reaction between the sodium aluminate, the sulfate ions, and the calcium ions.

In some embodiments, the sodium aluminate solution contains between 35% and 50% sodium aluminate.

In some embodiments, the volume of sodium aluminate solution is equal to between 0.1% and 0.3% of the volume of the process water.

In another embodiment, a system for treating process water from a cementitious article forming process is described. The system includes a reaction tank in fluid communication with a process water flow path associated with the cementitious forming process, the reaction tank including an agitator; a reagent tank containing a sodium aluminate solution, the reagent tank in fluid communication with the reaction tank; metering equipment including at least one of a valve and a pump, the metering equipment configured to cause a predetermined volume of the sodium aluminate solution to flow from the reagent tank into the reaction tank; a clarifier in fluid communication with the reaction tank; and a filter in fluid communication with the clarifier. The process water flow path is configured to send, to the reaction tank, spent process water including sulfate ions and calcium ions produced by the cementitious article forming process. The sodium aluminate solution reacts with the sulfate ions and calcium ions to form a solid precipitate including ettringite. The clarifier and the filter are configured to at least partially separate the solid precipitate from the process water to produce a volume of treated process water and a quantity of solid waste.

In some embodiments, the predetermined volume of the sodium aluminate solution is determined based at least in part on a concentration of sulfate or calcium ions in the spent process water.

In some embodiments, the predetermined volume of the sodium aluminate solution is between 0.1% and 0.3% of a volume of spent process water in the reaction tank.

In some embodiments, the sodium aluminate solution comprises between 35% and 50% sodium aluminate.

In some embodiments, the clarifier includes a slant plate clarifier configured to output a clarified liquid and a sludge.

In some embodiments, the filter is configured to receive the sludge and output a solid waste and a liquid filtrate.

In some embodiments, the system further includes at least one additional reaction tank in fluid communication with the process water flow path, the reagent tank, and the clarifier, wherein the metering equipment is configured to independently control a first flow of sodium aluminate into the reaction tank and a second flow of sodium aluminate into the at least one additional reaction tank.

In another embodiment, a cementitious shaped article manufacturing system is described. The system includes a forming unit configured to form a cementitious shaped article, such as a fiber cement board, wherein the forming unit discharges spent process water containing at least sulfate ions and calcium ions; a wastewater treatment unit configured to treat at least a portion of the spent process water by mixing the spent process water with sodium aluminate to form a solid precipitate, and removing the solid precipitate from the spent process water to produce a treated process water having a concentration of sulfate ions relatively lower than an initial concentration of sulfate ions in the spent process water; and a discharge unit configured to adjust the pH of the treated process water.

In some embodiments, the wastewater treatment unit includes a clarifier and a filter for removing the solid precipitate from the spent process water.

In some embodiments, the treated process water is substantially free of the solid precipitate.

### BRIEF DESCRIPTION OF THE DRAWINGS

Certain embodiments of the present disclosure will now be described, by way of example only, with reference to the accompanying drawings. From figure to figure, the same or similar reference numerals are used to designate similar components of an illustrated embodiment.

FIG. 1 is a schematic diagram of an example cementitious building article manufacturing process which incorporates a wastewater treatment process in accordance with an example embodiment.

FIG. 2 is a schematic diagram of an example wastewater transfer process for delivering wastewater from a forming process to a wastewater treatment process.

FIG. 3 is a schematic diagram of an example wastewater treatment process for removing sulfate and calcium ions from wastewater.

FIG. 4 is a schematic diagram of an example precipitated sludge dewatering process for further treating the output of the wastewater treatment process of FIG. 3.

FIG. 5 is a schematic diagram of an example treatment process for removing ions from a concentrate produced by reverse osmosis treatment of wastewater.

FIG. 6A is a graph illustrating the reduction of sulfate ion concentration in process water with several example sodium aluminate dosages.

FIG. 6B is a graph illustrating the reduction of calcium ion concentration in process water with the example sodium aluminate dosages of FIG. 6A.

FIG. 7A is a graph illustrating the effect of an example flocculant on the settling time of precipitates produced by sodium aluminate in accordance with the present disclosure.

FIG. 7B depicts the effect of the example flocculant of FIG. 7A on the settling time of precipitates produced by sodium aluminate.

FIG. 8 is a graph illustrating the distribution of particle sizes of precipitates formed by an example reaction of process water with sodium aluminate.

FIG. 9A is a graph illustrating the reduction of sulfate ion concentration in reverse osmosis concentrate with several example sodium aluminate dosages.

FIG. 9B is an x-ray diffraction pattern and corresponding component analysis indicating the components of the solids generated by treatment of reverse osmosis concentrate.

### DETAILED DESCRIPTION

Although the present disclosure is described with reference to specific examples, it will be appreciated by those skilled in the art that the present disclosure may be embodied in many other forms. The embodiments discussed herein are merely illustrative and do not limit the scope of the present disclosure.

In the description which follows, like parts may be marked throughout the specification and drawings with the same reference numerals. The drawing figures are not necessarily to scale and certain features may be shown exaggerated in scale or in somewhat generalized or schematic form in the interest of clarity and conciseness.

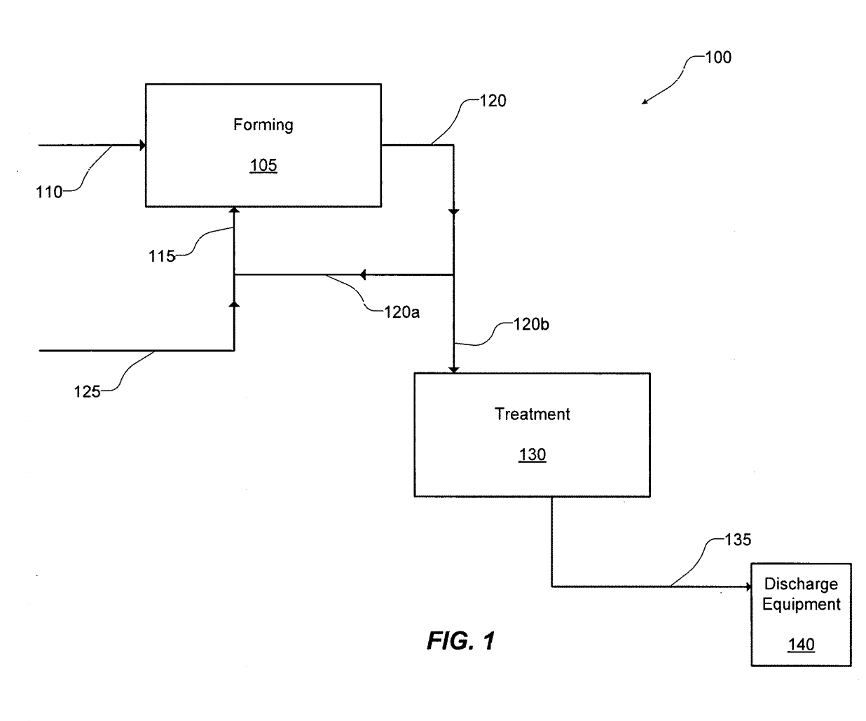

The present disclosure describes water treatment processes for removing ions leached from cement in process water and/or wastewater generated in connection with the manufacture of cementitious building articles, such as fiber cement or the like. FIG. 1 schematically illustrates a cementitious building article manufacturing system 100, which incorporates a novel water treatment process that efficiently and cost-effectively removes sulfate and calcium ions from spent process water, or wastewater, before discharge. The system 100 generally comprises a forming unit 105 adapted to form shaped cementitious articles, a treatment unit 130 configured to remove sulfate and calcium ions from process water entering the treatment unit 130, and discharge equipment 140 for final treatment and discharge of wastewater effluent. The forming unit 105 may include any water-based cementitious article forming processes known in the art.

As shown in FIG. 1, the forming unit 105 receives process water including fresh water 110 and recycled water 115, which are used in the cementitious article forming process. The relative quantities of fresh water 110 and recycled water 115 may be selected so as to provide an acceptably low concentration of impurities (e.g., sulfate, calcium, sodium, and/or potassium ions) that may be present in the recycled water. As the forming unit 105 forms cementitious articles, used process water 120 is produced, containing various residues, impurities, and/or ions leached from cement in the forming process. Process water 120 is divided into a recycle stream 120a and a waste stream 120b. The recycle stream 120a of the process water 120 can be retained and diluted with additional fresh water 125 to form the recycled water 115 and cycled back into the forming unit 105 to be used for forming additional cementitious articles. In some embodiments, the forming unit 105 may utilize fresh water 110 for certain components that require cleaner water for continued operation, and utilize the diluted recycled water 115 for other components of the forming unit 105 that do not require fresh water.

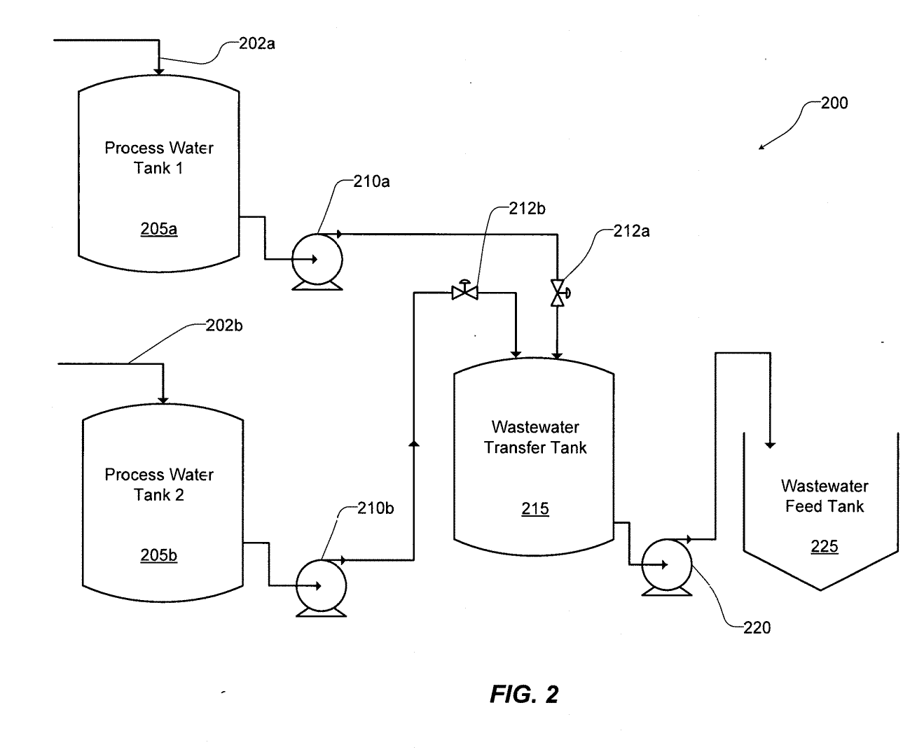

When the recycle stream 120a of the process water 120 is retained, the remaining portion forms the waste stream 120b to be discharged as effluent. The quantities and/or concentrations of various residues, impurities, ions, and the like contained within effluent may be subject to discharge permit or contract restrictions, or other regulation. Thus, the waste stream 120b is sent to the treatment unit 130 for removal of at least a portion of the constituent materials in the waste stream 120b. Components and processes of the treatment unit 130, such as those for removal of sulfate and/or calcium ions, will be discussed in greater detail with reference to FIGS. 2-4. After treatment, treated wastewater 135 is sent from the treatment unit 130 to the discharge equipment 140. In various embodiments, discharge equipment 140 can include components such as pipes and/or conduits for transferring the treated wastewater 135 to a discharge site, and/or equipment for further treating the treated wastewater 135, such as by additional filtration, clarifying, pH adjustment by carbon dioxide treatment, or the like.

Generally described, the novel treatment processes described herein include combining the waste stream 120b of process water 120, which contains sulfate (SO₄²⁻) and calcium (Ca²⁺) ions, with a solution containing sodium aluminate (NaAlO₂) to produce a solid precipitate comprising at least a substantial portion of the sulfate and calcium ions. The resultant precipitate is composed primarily of ettringite, and may further include a smaller quantity of calcium sulfate (gypsum). The primary chemical reaction between the sulfate ions, calcium ions, and sodium aluminate in water to produce ettringite is generally characterized by:

2/3NaAlO₂+SO₄⁻²+2Ca⁺²=1/3(Ca₆Al₂(SO₄)₃(OH)₁₂.26H₂O), (1)

as 2/3 mole of sodium aluminate react with 1 mole of sulfate ions and 2 moles of calcium ions to produce 1/3 mole of ettringite. In addition, a smaller quantity of calcium sulfate (CaSO₄) may be formed by the reaction of calcium (Ca²⁺) ions with sulfate (SO₄²⁻) ions in solution.

The novel sodium aluminate wastewater treatment processes described herein may provide various advantages over existing water treatment processes for removal of sulfate and/or calcium ions. For example, the sodium aluminate treatment described herein may be relatively less expensive than existing methods, such as ion exchange or treatment with barium chloride. In addition, the reaction between sodium aluminate, sulfate and calcium ions is relatively rapid, especially under moderate agitation, such that each batch of wastewater may be treated quickly (e.g., less than 15-20 minutes of reaction time).

The processed wastewater and precipitated solids produced by the present processes may have further advantageous qualities. In one example, the low calcium concentration in the treated wastewater produced by the processes described herein may significantly improve the functionality of other downstream treatment processes, for example, reverse osmosis or other treatment processes, that may be used to further treat the wastewater before release as effluent. In another example, the precipitated ettringite and/or gypsum solids may have a relatively large particle size, allowing them to be separated during sludge dewatering by traditional filtration methods that may not be effective with existing treatment processes. The addition of a flocculant, coagulating, dewatering, or settling agent such as, for example, a polyacrylamide, may further increase the particle size and improve filtration efficiency.

As will be described in greater detail, the chemical reactions between sodium aluminate and wastewater containing ion contaminants can be carried out in one or more treatment tanks. The resulting suspension of liquid and precipitate can be clarified, such as by a settling tank, slant plate clarifier, or other clarifying apparatus, to produce a clarified process water and a sludge. The sludge can further be dewatered to yield a solid waste that can be disposed of conveniently, such as in a landfill or other waste disposal site. The clarified process water can be further treated, such as by pH adjustment or other final treatment processes, and released as effluent, for example, to a municipal wastewater system or the like.

Turning now to FIG. 2, an example system and process will be described for transferring wastewater from a cementitious article forming process to a wastewater treatment process. A wastewater transfer system 200 generally includes one or more process water tanks 205a, 205b, a wastewater transfer tank 215, and a wastewater feed tank 225. Fluid is transferred from the process water tanks 205a, 205b to the wastewater transfer tank 215 by process water tank pumps 210a, 210b. Fluid flow into the wastewater transfer tank 215 can be allowed, limited, and/or stopped by valves 212a, 212b. Fluid is transferred from the wastewater transfer tank 215 to the wastewater feed tank 225 by a pump 220.

The one or more process water tanks 205a, 205b are in fluid communication with a process water flow path of a manufacturing apparatus and configured to receive wastewater streams 202a, 202b comprising waste or excess process water from the manufacturing apparatus. For example, the one or more process water tanks 205a, 205b may be configured to receive the waste stream 120b from the forming unit 105 depicted in FIG. 1. In some embodiments, a single process water tank 205a may be used. In other embodiments, any larger number of process water tanks 205a, 205b may be utilized. The number and size of process water tanks 205a, 205b may be determined based at least in part on the number of manufacturing machines or forming units generating wastewater, so as to maintain sufficient capacity to receive all or substantially all waste process water that is not recycled.

Wastewater that has been collected in process water tanks 205a, 205b is transferred to the common wastewater transfer tank 215 by process water tank pumps 210a, 210b. Process water tank pumps 210a, 210b can be centrifugal pumps or any other suitable pump for moving wastewater in a pipe. The flow of wastewater between process water tanks 205a, 205b and the wastewater transfer tank 215 is further controllable by the position of valves 212a, 212b. Valves 212a, 212b can be opened, closed, partially opened, and/or partially closed as desired to provide an appropriate flow rate from each process water tank 205a, 205b to the wastewater transfer tank 215. Valves 212a, 212b can be operable automatically, manually, and/or remotely. Wastewater in the wastewater transfer tank can then be transferred to the wastewater feed tank 225 by the transfer tank pump 220. The transfer tank pump 220 can be a centrifugal pump or any other suitable pump for moving wastewater in a pipe.

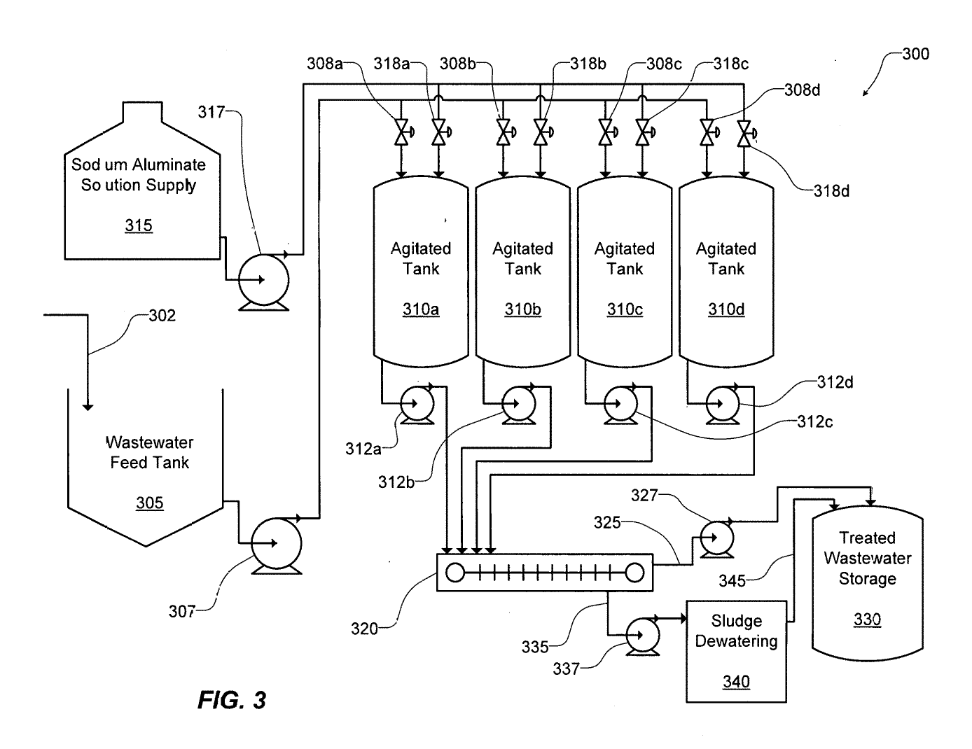

In some embodiments, the configuration of process water tanks 205a, 205b, wastewater transfer tank 215, and wastewater feed tank 225 may be advantageous by providing added temporary storage capacity. As will be described with reference to FIG. 3, at least some of the wastewater treatment processes described herein may be performed as batch processes. Thus, the added upstream capacity provided by the tank configuration of FIG. 2 can facilitate the use of batch treatment processes with a continuous input such as a stream of waste process water from a cementitious article manufacturing unit.

Turning to FIG. 3, an example system and process for removing sulfate and calcium ions from wastewater will be described. A wastewater treatment system 300 includes a wastewater feed tank 305, agitated tanks 310a, 310b, 310c, 310d, a sodium aluminate solution supply tank 315, and a clarifier 320. The wastewater feed tank 305 can be any vessel configured to receive wastewater 302 containing at least sulfate and calcium ions from a cementitious article manufacturing process (e.g., the wastewater feed tank 225 depicted in FIG. 2). Generally described, the wastewater 302 from the wastewater feed tank 305 is combined with sodium aluminate from the sodium aluminate supply 315 in the agitated tanks 310a, 310b, 310c, 310d to produce a precipitate, which can be at least partially removed from the wastewater 302 in the clarifier 320. The removed solids in the form of a sludge 335 can be sent to a sludge dewatering unit 340, while the clarified wastewater 325 can be sent to a treated wastewater storage 330.

The flow of wastewater 302 from the wastewater feed tank 305 to the agitated tanks 310a, 310b, 310c, 310d can be induced and precisely metered by a feed tank pump 307 and wastewater valves 308a, 308b, 308c, 308d. Similarly, the flow of sodium aluminate solution to the agitated tanks 310a, 310b, 310c, 310d can be induced and precisely metered by a sodium aluminate supply pump 317 and sodium aluminate valves 318a, 318b, 318c, 318d. Once the desired quantities of wastewater 302 and sodium aluminate solution are combined in one of the agitated tanks 310a, 310b, 310c, 310d, the mixture can be agitated for an appropriate reaction period, such as 5 minutes, 10 minutes, 15 minutes, or longer, to achieve thorough mixing and/or a more complete reaction of the wastewater 302 and the sodium aluminate solution.

The volumetric ratio of sodium aluminate solution to wastewater can be determined based on stoichiometric principles so as to provide sufficient sodium aluminate to achieve the precipitation reaction and/or to avoid wasting excess sodium aluminate solution that will not be consumed. In some embodiments, the concentration of sulfate and calcium ions in the wastewater can be determined from a sample of the wastewater taken prior to treatment. Once the quantity of sulfate and calcium within the wastewater are known, the quantity of sodium aluminate can preferably be determined such that calcium and/or sulfate is a limiting reagent of the reaction. For example, a quantity of spent process wastewater may include approximately 1600 ppm of sulfate and approximately 900 ppm of calcium. As shown in equation 1 above, the reaction of sulfate and calcium to form each ettringite molecule consumes 2 sodium aluminate molecules, 3 sulfate ions, and 6 calcium ions. Thus, calcium can be a limiting reagent, and the quantity of sodium aluminate solution to be added to the wastewater can be selected such that sufficient sodium aluminate is present to consume all of the ionic calcium present in the wastewater.

In some embodiments, the sodium aluminate is provided in a solution containing between 30% and 60% sodium aluminate. In some embodiments, the solution contains between 35% and 40%, such as 38%, sodium aluminate. In some embodiments, the solution contains between 40% and 50%, such as 45%, sodium aluminate. In one embodiment, a 38% solution of sodium aluminate with sodium hydroxide as a buffering agent is used as a reagent to react with the calcium and sulfate ions in the process water. In some embodiments, the quantity of sodium aluminate solution is between 0.5 and 5 gallons for each 1000 gallons of wastewater, for example, between 1 gallon and 5 gallons, between 1 gallon and 2 gallons, or other suitable quantity. In one example implementation, the volumetric ratio is approximately 1.62 gallons of 38% sodium aluminate solution per 1000 gallons of wastewater. Thus, the volume of the sodium aluminate solution can be in the range of 0.05% to 0.5% of the volume of wastewater to which the sodium aluminate solution is added. In various embodiments, the volumetric ratio of sodium aluminate to wastewater can be adjusted for each treatment batch based on a detected concentration of calcium and/or sulfate ions in the wastewater.

Preferably, because the agitated reaction is a batch process, each tank 310a, 310b, 310c, 310d is closed during the reaction period. For example, the feed tank pump 307 can be activated with valve 308a open and valves 308b, 308c, and 308d closed, such that the wastewater 302 flows only into tank 310a. When the desired reaction volume of wastewater 302 has been pumped into tank 310a, valve 308a is closed and valve 308b is opened such that the wastewater 302 can begin filling tank 310b, or the feed tank pump 307 can be deactivated. During or after the filling of tank 310a, the sodium aluminate supply pump 317 is activated with valve 318a open and valves 318b, 318c, and 318d closed, such that calcium aluminate solution flows into tank 310a. When the desired volume of sodium aluminate solution has been pumped into tank 310a, valve 318a is closed and the sodium aluminate supply pump 317 is deactivated. After a first tank 310a has been filled with the appropriate quantities of wastewater 302 and sodium aluminate solution, the treatment system 300 can proceed to fill a second tank 310b, 310c, or 310d.

During the reaction period, the sodium aluminate in the tank 310a reacts with the sulfate and calcium ions in the wastewater 302 according to chemical equation (1) above, producing a solid precipitate of ettringite suspended in the wastewater 302. In addition, a portion of the calcium and sulfate ions in the wastewater 302 may interact during the reaction to form a relatively small quantity of calcium sulfate (e.g., 10% or less of the total volume of solid precipitate). Thus, the result of the mixing and agitation in tank 310a is a colloidal suspension of solid precipitate suspended in wastewater 302, which may be in the form of a dilute slurry of ettringite, gypsum, and process water. A further result of the reaction period is that the liquid portion of the precipitate-laden wastewater 302 has a lower concentration of sulfate and calcium ions relative to the wastewater 302 that was pumped into the tank 310a.

At the end of the reaction period, each tank 310a, 310b, 310c, 310d can be emptied independently by activation of a tank outlet pump 312a, 312b, 312c, 312d. Tank outlet pumps 312a, 312b, 312c, and 312d can be centrifugal pumps or other suitable liquid pumps capable of transferring a suspension or slurry. Each tank outlet pump 312a, 312b, 312c, 312d is in fluid communication with its respective tank 310a, 310b, 310c, 310d and the clarifier 320 so as to pump the contents of the tank 310a, 310b, 310c, 310d to the clarifier 320.

The clarifier 320 can comprise one or more of a settling tank, rectangular clarifier, tube settler, slant plate clarifier, or the like. At the clarifier, solid precipitate matter produced in one of tanks 310a, 310b, 310c, 310d is removed from the wastewater 302 by settling or other suitable clarifying process. After clarifying, the clarifier 320 outputs clarified wastewater 325, which can be substantially free of precipitate, and sludge 335 comprising the solid precipitate and a portion of the liquid wastewater 302. A clarified wastewater pump 327 transfers the clarified wastewater 325 from the clarifier 320 to the treated wastewater storage 330. A sludge pump 337 transfers the sludge 335 from the clarifier 320 to the sludge dewatering unit 340.

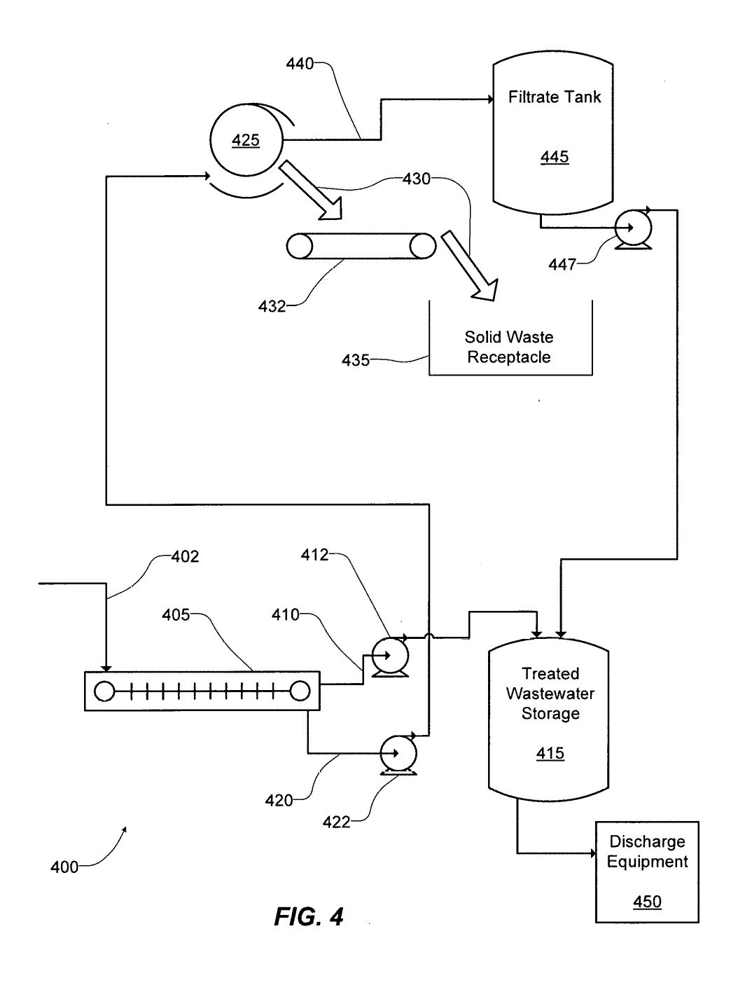

The sludge dewatering unit 340, described in greater detail below with reference to FIG. 4, further separates the sludge 335 into a solid waste and a liquid filtrate 345 suitable for transfer to the treated wastewater storage 330, where it is combined with the clarified wastewater 325. The treated wastewater 325 in the treated wastewater storage 330 can be stored and/or released as effluent, for example, into a municipal wastewater treatment system or the like. The solid waste may be disposed of by known methods of solid waste disposal.

In some embodiments, a flocculant, clarifying, coagulating, dewatering, or settling agent such as, for example, a polyacrylamide, can further be added in the wastewater treatment system 300 to facilitate the clarification process. In some embodiments, the flocculant can be added to the mixture of wastewater 302 and sodium aluminate in a tank 310a, 310b, 310c, 310d, at any time during the reaction period. In other embodiments, the flocculant can be added after the reaction period, for example, by being metered into the fluid flow path between a tank 310a, 310b, 310c, 310d and the clarifier 320. Preferably, the flocculant is incorporated into the treated wastewater 302 before the wastewater 302 and precipitate reach the clarifier 320.

Turning now to FIG. 4 an example precipitated sludge dewatering process will be described for further treating the sludge 335 produced by the clarifier 320 of FIG. 3. As shown in FIG. 4, a sludge dewatering system 400 generally includes a clarifier 405, a filter 425, a solid waste receptacle 435, and a filtrate tank 445. Generally described, the sludge dewatering process carried out by the sludge dewatering system 400 includes further removing liquid from a sludge 420 produced by the clarifier 405 to produce a solid waste 430 for convenient disposal, and a filtrate 440 substantially free of precipitated solids and suitable for final processing and discharge as effluent.

As described above with reference to FIG. 3, the clarifier 405 receives a treated wastewater stream 402, which may comprise a colloidal suspension or slurry of precipitated solids in wastewater. The clarifier 405 clarifies the treated wastewater stream 402 to yield sludge 420 and a clarified wastewater 410. A clarified wastewater pump 412 transfers the clarified wastewater 410 to a treated wastewater storage 415.

The sludge 420 is transferred for dewatering by a sludge pump 422. The sludge pump 422 can be a centrifugal pump or the like. The sludge pump 422 transfers the sludge 420 to the filter 425. The filter 425 can be any filter suitable for retaining solid precipitate particles, such as a rotary filter, a drum filter, a vacuum drum filter, a bag filter, an inertial separator, or the like. The filter 425 allows a filtrate 440 portion of the sludge 420 to pass, while removing from the sludge 420 a solid waste 430 containing relatively little or none of the liquid treated wastewater 402. The solid waste 430 is removed from the filter 425 and transported by a conveyor 432 or other transport apparatus to a solid waste receptacle 435, such as a dumpster or other waste container, for disposal. The filtrate 440 is transferred to the filtrate tank 445, where it is stored and/or sent by a filtrate pump 447 to the treated wastewater storage 415.

At the treated wastewater storage 415, the filtrate 440 is combined with the clarified wastewater 410 output from the clarifier 405. After having the solid waste 430 removed, the filtrate 440 portion of the sludge 420 may have a substantially similar or identical composition to the clarified wastewater 410. The filtrate 440 and clarified wastewater 410 as combined in the treated wastewater storage 415 typically have a significantly reduced concentration of sulfate and calcium ions relative to the original output of the cementitious article forming units described herein. The sulfate and calcium ions removed from the treated wastewater stream 402 are generally contained within the solid waste 430, which may be disposed of safely (e.g., in a landfill, etc.) without releasing its components into a water system such as a municipal wastewater system, ground water, or the like.

Preferably, the sulfate and calcium ion concentration of the treated wastewater in the treated Wastewater storage 415 are low enough to comply with any regulations and/or other limits on effluent sulfate and/or calcium concentration, such that the contents of the treated wastewater storage 415 can be discharged as effluent without requiring further treatment for removal of calcium or sulfate. The treated wastewater in the treated wastewater storage 415 is transferred to discharge equipment 450 for final treatment and/or release. In some implementations, further treatment may be required to treat aspects of the wastewater other than calcium and sulfate ion concentration. For example, the discharge equipment 450 can include known treatment systems such as ion exchange for removal of other ionic constituents, a final filtration or clarifying stage, reverse osmosis, or the like. In another example, the discharge equipment 450 can include a carbonation tank or other pH adjustment apparatus configured to raise or lower the pH of the treated wastewater into an acceptable pH range for discharge as effluent.

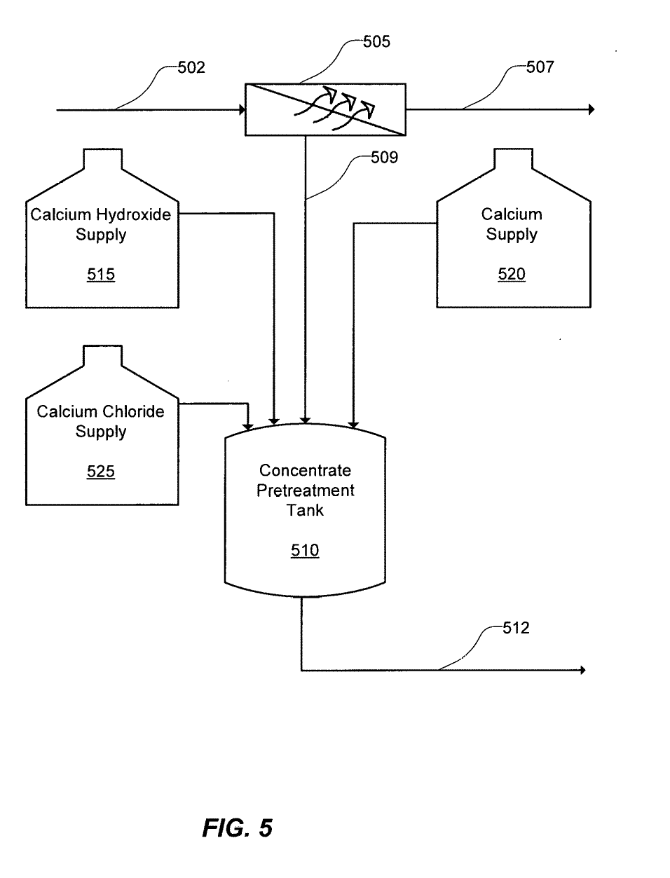

With reference to FIG. 5, an example process will be described for reverse osmosis treatment of the wastewater 302 of FIG. 3, and/or for treatment of the filtrate 440 and/or clarified wastewater 410 produced in FIG. 4. In some embodiments, the process of FIG. 5 can be used for treatment of the already treated filtrate 440 and/or clarified wastewater 410. Alternatively, the process of FIG. 5 can be used as an initial treatment of wastewater 302 prior to the sodium aluminate treatment of FIG. 3 and sludge dewatering of FIG. 4.

As shown in FIG. 5, the reverse osmosis and concentrate treatment components include a reverse osmosis system 505, a concentrate pretreatment tank 510, a calcium hydroxide supply 515, a calcium supply 520, and a calcium chloride supply 525. The components of FIG. 5 may comprise a portion of the discharge equipment 140, 450 depicted in FIGS. 1 and 4, and/or may comprise an intermediate treatment process between the forming unit 105 and treatment unit 130. Generally described, the treatment process carried out by the components of FIG. 5 includes treating the wastewater 302 of FIG. 3 and/or the filtrate 440 and/or clarified wastewater 410 of FIG. 4 (received as a reverse osmosis input stream 502) by reverse osmosis to produce a reverse osmosis permeate 507 and a reverse osmosis concentrate 509. The reverse osmosis permeate 507 can be discharged or further treated for discharge, while the reverse osmosis concentrate 509 can undergo additional treatment.

The reverse osmosis input stream 502 comprises the solution produced by the treatment processes depicted in FIGS. 2-4. Thus, the reverse osmosis input stream 502 comprises water having various ions dissolved therein, including sulfate, calcium, sodium, and potassium. In some implementations (e.g., depending on local discharge requirements, equipment maintenance considerations, etc.), one or more of the ions in the reverse osmosis input stream 502 may still be present in an undesirably high concentration after being treated by the process of FIGS. 2-4. Thus, the reverse osmosis input stream 502 can be treated at the reverse osmosis system 505.

At the reverse osmosis system 505, the reverse osmosis input stream 502 is treated by known reverse osmosis methods using a semi-permeable membrane. A portion of the reverse osmosis input stream 502 passes through the semi-permeable membrane, emerging from the reverse osmosis system 505 as the reverse osmosis permeate 507 containing a lower concentration of sulfate, calcium, sodium, and potassium ions relative to the reverse osmosis input stream 502. The remaining portion of the reverse osmosis input stream 502 does not pass through the semi-permeable membrane, and is released as the reverse osmosis concentrate 509 containing a higher concentration of sulfate, calcium, sodium, and potassium ions relative to the reverse osmosis input stream 502. Generally, the volume of the reverse osmosis permeate 507 is larger than or similar to the volume of the reverse osmosis concentrate 509 (e.g., 50% permeate and 50% concentrate, 60% permeate and 40% concentrate, 70% permeate and 30% concentrate, 80% permeate and 20% concentrate, 90% permeate and 10% concentrate, etc.). Thus, the reverse osmosis concentrate 509 may have significantly higher concentrations of sulfate, calcium, sodium, and/or potassium ions.

The reverse osmosis concentrate 509 may be treated by similar processes to those described with reference to FIGS. 2-4, for example, by adding a sodium aluminate solution to convert some or all of the ions to an ettringite precipitate. In some embodiments, the reverse osmosis concentrate 509 may be reintroduced to the sodium aluminate treatment process as a component of the wastewater 302 depicted in FIG. 3, and/or can be treated by the same or similar process separately from the wastewater 302 (e.g., in one of the agitated tanks 310a, 310b, 310c, 310d not containing wastewater 302). However, the reverse osmosis concentrate 509 may have a significantly different composition (e.g., different concentrations of the constituent ions) relative to the wastewater 302, because the reverse osmosis concentrate 509 is produced by reverse osmosis treatment of treated wastewater, rather than by a cementitious article forming process. For example, the reverse osmosis concentrate 509 may have higher concentrations of sulfate, sodium, and potassium ions than the wastewater 302, and may have a lower pH. Accordingly, the reverse osmosis concentrate 509 can be pretreated to be rendered suitable for ettringite formation.

The reverse osmosis concentrate 509 can be pretreated, for example, in the concentrate pretreatment tank 510. In some embodiments, the pretreatment can be accomplished without a tank by adding components to the reverse osmosis concentrate 509 traveling in a pipe or other conduit. In some embodiments, the concentrate pretreatment tank 510 can be an agitated tank to facilitate mixing of the reverse osmosis concentrate 509 with added components.

The example concentrate treatment process begins with pH adjustment. Calcium hydroxide (e.g., lime) from the calcium hydroxide supply 515 is added to the reverse osmosis concentrate 509 in the concentrate pretreatment tank 510. Additional calcium may further be added to the reverse osmosis concentrate 509 from the calcium supply 520. Quantities of calcium hydroxide and calcium can be determined, for example, based on a desired pH range. In one example, calcium hydroxide and calcium are added to control the pH of the reverse osmosis concentrate 509 within a range such as between 11.5 and 12.5 or other suitable range for ettringite formation.

After the pH is adjusted in the concentrate pretreatment tank 510, calcium chloride is added to the concentrate pretreatment tank 510 from the calcium chloride supply 525. Calcium chloride may be desirable as an additional component in order to provide sufficient calcium for the formation of ettringite. As shown in equation (1) above, a relatively large quantity of calcium is required for the formation of ettringite. Moreover, because the reverse osmosis input stream 502 has already been treated by ettringite formation, the reverse osmosis concentrate 509 may have relatively high concentrations of sulfate, sodium, and potassium, and a relatively lower concentration of calcium. Accordingly, the addition of calcium hydroxide, calcium, and calcium chloride may advantageously provide sufficient calcium for further ettringite formation from the reverse osmosis concentrate.

After the calcium hydroxide, calcium, and calcium chloride are added to the reverse osmosis concentrate 509 in the concentrate pretreatment tank 510, the pretreatment process terminates, producing a pretreated concentrate 512 suitable for treatment with sodium aluminate. Sodium aluminate can then be reacted with the sulfate and calcium ions in the pretreated concentrate 512 to produce a precipitate primarily comprising ettringite, as well as other components such as calcium sulfate or the like. In some embodiments, the sodium aluminate reaction may be achieved within the discharge equipment 450 (FIG. 4). Alternatively, and with joint reference to FIGS. 3 and 5, the pretreated concentrate 512 may be reintroduced to the wastewater treatment system 300, such that the pretreated concentrate 512 can be treated simultaneously with newly produced wastewater 302. For example, the pretreated concentrate 512 can be transferred into the wastewater feed tank 305 and combined with the wastewater 302. In another example, the pretreated concentrate 512 can be transferred directly into one of the agitated tanks 310a, 310b, 310c, 310d for treatment with sodium aluminate. It will be appreciated that, although the pretreated concentrate 512 may differ in composition from the wastewater 302, the pretreatment process described above with reference to FIG. 5 may produce a pretreated concentrate 512 including appropriate concentrations of calcium and sulfate ions to be treatable by the same process described with reference to FIG. 3 to produce an ettringite precipitate.

As described above, the reverse osmosis and concentrate pretreatment process of FIG. 5 may be performed either before the treatment process of FIG. 3 or after the treatment and sludge dewatering processes of FIGS. 3 and 4. In some embodiments, treatment by reverse osmosis before the treatment process of FIG. 3 may have certain advantages. For example, if the wastewater 302 is first treated by reverse osmosis, the reverse osmosis permeate 507 may be discharged with little to no additional treatment, while only the reverse osmosis concentrate 509 would need to be treated by the processes of FIGS. 3 and 4. Because the reverse osmosis concentrate 509 generally comprises a small portion (e.g., as low as 10% or 20% of the total reverse osmosis input stream 502), this ordering may allow for a much smaller volume of wastewater flow to be treated, resulting in reduced need for treatment materials and time. Moreover, naturally occurring calcium sulfate may precipitate as well, reducing the need for additional chemicals. In addition, the ettringite treatment processes described herein may result in a desirable reduction in total dissolved solids (TDS) of approximately 25%.

### EXAMPLES

### Ion Removal Testing

A series of tests were carried out to determine the effectiveness of ion removal using various doses of sodium aluminate with spent process water. Wastewater containing approximately 1611 ppm of sulfate ions and approximately 897 ppm of calcium ions was combined with a 38% sodium aluminate solution. Three dosages of sodium aluminate solution were tested. The three tested dosages were 75%, 100%, and 125% of a proposed dosage of 1.62 gallons of sodium aluminate solution per 1000 gallons of wastewater. Thus, the three tested dosages correspond to 1.215, 1.62, and 2.025 gallons of sodium aluminate solution per 1000 gallons of wastewater, respectively. Each test dosage of 38% sodium aluminate solution was combined with sample of the wastewater, and the sulfate and calcium ion concentrations were sampled at 5 minute intervals for 25 minutes, and sampled again after total reaction times of 35 minutes and 45 minutes.

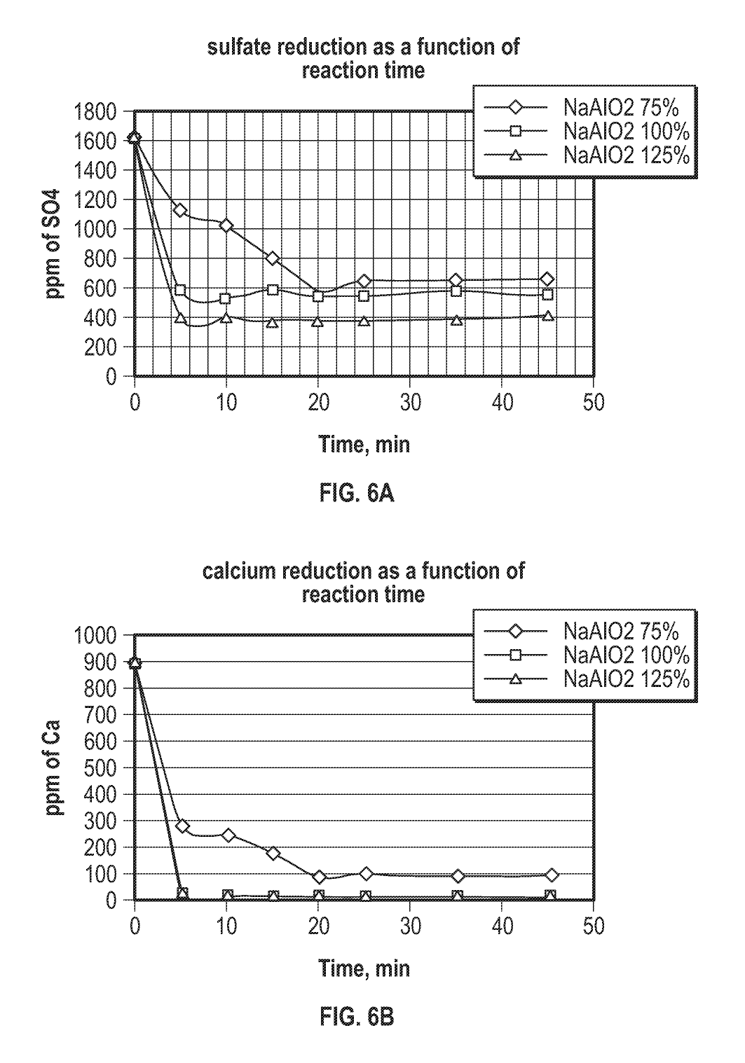

FIG. 6A is a graph illustrating the resulting reduction of sulfate ion concentration in the wastewater. As shown in FIG. 6A, the 100% and 125% dosages of sodium aluminate solution were significantly more effective in removing sulfate relative to the 75% dosage. For example, after 5 minutes, the 100% dosage removed approximately 1000 ppm of sulfate, and the 125% dosage removed approximately 1200 ppm of sulfate, while the 75% dosage only removed approximately 500 ppm of sulfate. In addition, the graph of FIG. 6A illustrates a point of diminishing returns for the 100% and 125% dosages at 5 minutes of reaction time, confirming that a mixing time of 10 minutes, 15 minutes, or longer as described above with reference to FIG. 3 can provide sufficient time for the sulfate precipitation reaction to be substantially completed. Thus, the tests show that the 100% and 125% dosages not only removed more sulfate ions from the wastewater, but removed sulfate ions at a significantly higher rate as well.

FIG. 6B is a graph illustrating the reduction of calcium ion concentration in the wastewater with the example sodium aluminate dosages of FIG. 6A. As shown in FIG. 6B, the 100% and 125% dosages of sodium aluminate solution were also significantly more cffcctive in removing calcium ion concentration relative to the 75% dosage. For example, after 5 minutes, the 100% and 125% dosages both removed substantially all calcium ions from the wastewater, while the 75% dosage removed only 600 ppm. Similar to the sulfate precipitation depicted in FIG. 6A, the 100% and 125% dosages produced a point of diminishing returns at 5 minutes of reaction time. The 75% dosage took much longer to finish reacting with free calcium ions, displaying a point of diminishing returns at 20 minutes and never removing substantially all of the calcium ions from the wastewater. Thus, similar to the sulfate reduction results described above, the 100% and 125% dosages increased both the amount of calcium ions removed as well as the rate of removal.

### Flocculation Testing

A series of tests were carried out to evaluate the effect of a flocculant on the settling time of the precipitate produced by the reaction of sodium aluminate with sulfate and calcium ions in wastewater. A polyacrylamide flocculant was combined with two samples of sodium aluminate treated wastewater in concentrations of 0.66 ppm and 3.9 ppm. A third sample of the sodium aluminate treated wastewater was allowed to settle as a control sample without the addition of flocculant. The flocculation testing was carried out in three graduated settling cones. The volume within each cone occupied by the settling solids was measured repeatedly between 0 and 30 minutes of settling time.

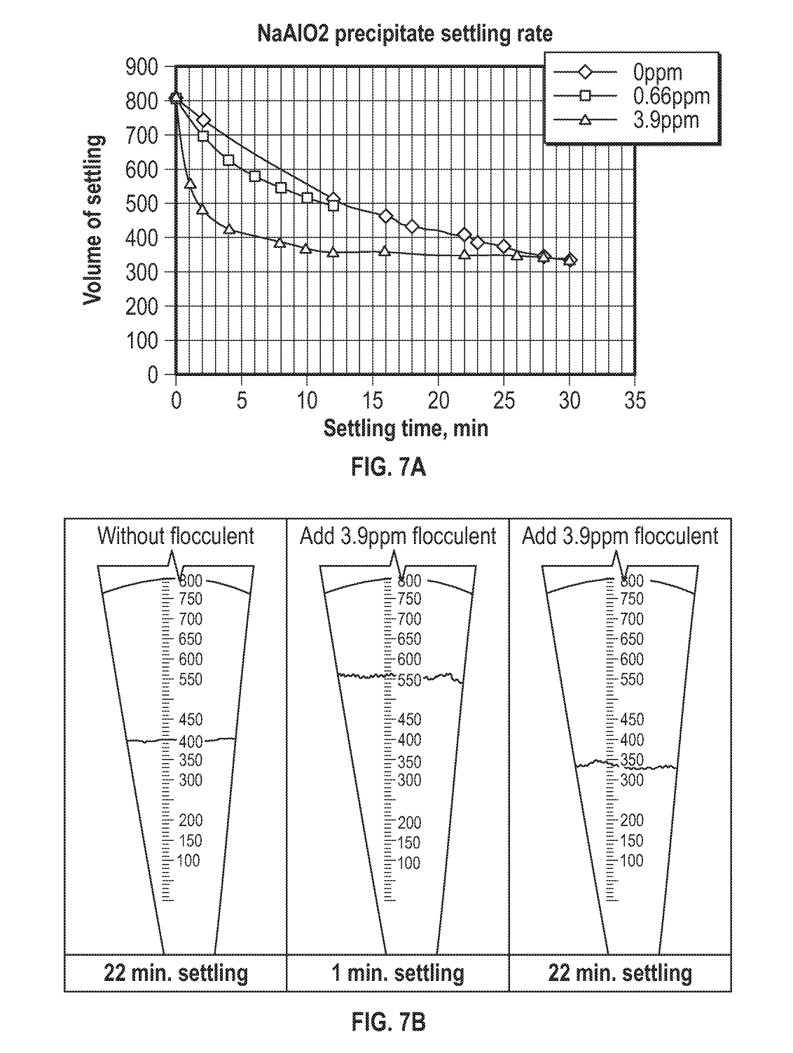

FIG. 7A is a graph illustrating the settling times observed in the flocculation testing. FIG. 7B depicts the graduated cone containing the control sample after 22 minutes of settling time, as well as the graduated cone containing 3.9 ppm of flocculant after 1 minutes and 22 minutes of settling time. As shown in the graph of FIG. 7A, the addition of the flocculant at a concentration of 3.9 ppm significantly reduced the settling time required for the precipitated solids to settle out of the wastewater. For example, the volume occupied by the precipitated solids in the control sample decreased below 400 ml after approximately 22 minutes of settling time. The addition of 3.9 ppm of flocculant reduced the settling time to reach 400 ml to approximately 5 minutes. Similarly, the addition of 3.9 ppm of flocculant reduced the time required to reach the final settled solid volume of approximately 340 ml from approximately 30 minutes in the control sample to approximately 12 minutes. Thus, the flocculation testing as shown in FIGS. 7A and 7B indicates that the addition of a flocculant during the treatment processes described herein can enhance the efficiency of precipitate removal from the treated wastewater.

### Particle Size Testing

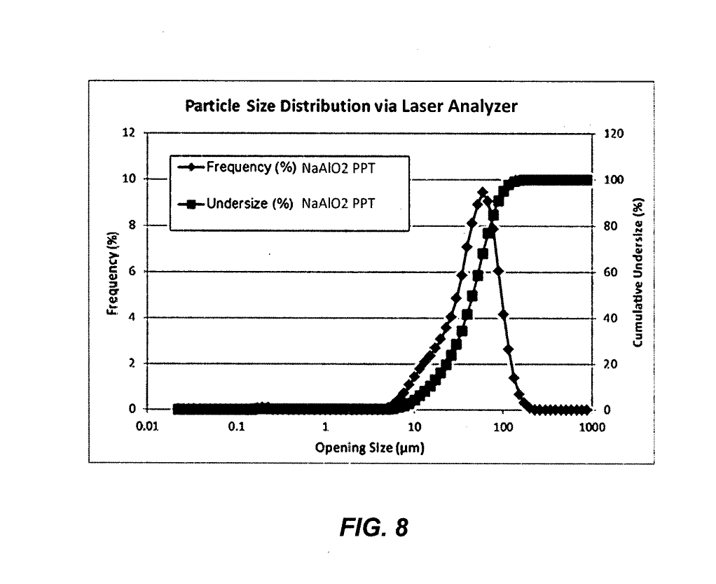

Particle size testing was carried out to evaluate the size of solid precipitate particles produced by the wastewater treatment processes described herein. After the sample wastewater was treated with sodium aluminate, the resulting precipitate was analyzed using a conventional laser particle size analyzer. FIG. 8 is a graph illustrating the distribution of the particle sizes as indicated by the laser particle size analysis. The graph of FIG. 8 shows both the particle size frequency and the cumulative percentage undersize of the analyzed solid precipitate particles.

The particles produced in the example process generally exhibited a normal distribution of particle sizes, ranging between approximately 5 microns and 200 microns. The normal distribution was centered on a mean particle size of approximately 49 microns. Conveniently, particles of an average size of 49 microns may readily be removed from process water by traditional means of solid-liquid separation, such as centrifugal separation, filtration means including bag filtration or rotary filtration, or the like.

### Sulfate Ion Removal Testing in Reverse Osmosis Concentrate

Sulfate ion removal testing was additionally performed on a sample of pretreated reverse osmosis concentrate using various doses of sodium aluminate. Pretreated reverse osmosis concentrate having a measured concentration of sulfate ions was treated with four dosages of 38% sodium aluminate solution. The four tested dosages were 100%, 125%, 150%, and 175% of a proposed dosage of 1.62 gallons of sodium aluminate solution per 1000 gallons of pretreated reverse osmosis concentrate. The calcium dosage in pretreatment was 125% of the theoretical value.

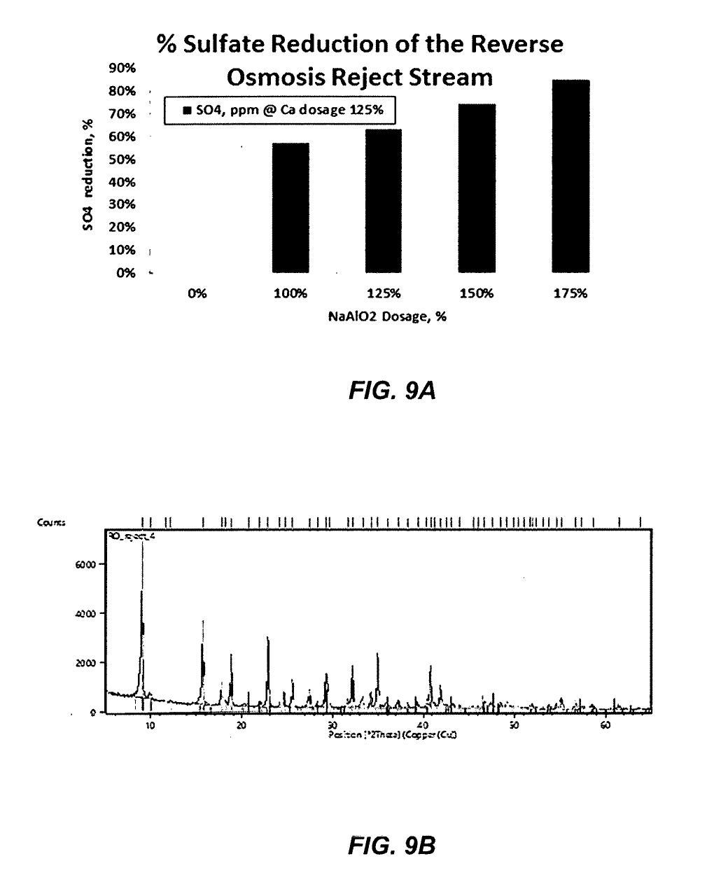

FIG. 9A is a bar graph illustrating the resulting reduction in sulfate ion concentration in the pretreated reverse osmosis concentrate. As shown in FIG. 9A, the 100% dosage of sodium aluminate solution resulted in a sulfate reduction of between 50% and 60%, the 125% dosage of sodium aluminate solution resulted in a sulfate reduction of approximately 60%, the 150% dosage of sodium aluminate solution resulted in a sulfate reduction of between 70% and 80%, and the 175% dosage of sodium aluminate solution resulted in a sulfate reduction of between 80% and 90%. Results of three individual trials performed with the 175% dose of sodium aluminate are presented in greater detail in Table 1 below.

TABLE 1
Sulfate ion reduction in pH-adjusted reverse osmosis concentrate by treatment with
sodium aluminate at a 175% dosage for 20 minutes.
RO Concentrate Testing—Constant Dosage and Time (20 minutes)

| | | | Al | Ca | | |
|---|---|---|---|---|---|---|
| | Calcium | Aluminum | Content | Content | SO4 | SO4 |
| | (% of | (% of | Residual | Residual | content | reduction |
| Trial Identification | theoretical) | theoretical) | (PPM) | (PPM) | (PPM) | (%) |
| T-1 Initial RO Concentrate | | | 3 | 5441 | 6183 | |
| (after pH adjusted) | | | | | | |
| 100% RO Concentrate | 125% | 175% | 47 | 752 | 956 | 85% |
| T-2 Initial RO Concentrate | | | 1 | 4510 | 4314 | |
| (after pH adjusted) | | | | | | |
| 100% RO Concentrate | 100% | 175% | 564 | 64 | 942 | 78% |
| T-3 Initial RO Concentrate | | | 1 | 4000 | 4500 | |
| (after pH adjust) | | | | | | |
| 100% RO | 125% | 175% | 360 | 21 | 110 | 98% |
| Concentrate—R1 | | | | | | |

In addition, the precipitated solids from the trials described above were analyzed by x-ray diffraction to determine constituent materials. FIG. 9B depicts an x-ray diffraction pattern corresponding to the solids removed by treatment of the pretreated reverse osmosis concentrate. Based on an analysis of the x-ray diffraction pattern, it was determined that the solid precipitate primarily comprises ettringite, gypsum, basanite (a gypsum precursor), as well as various polymorphs of quartz, such as cristobalite. The diffraction pattern additionally indicates the presence of calcite, which was likely produced by the exposure of the wet precipitate to atmospheric carbon dioxide.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Although making and using various embodiments are discussed in detail below, it should be appreciated that the description provides many inventive concepts that may be embodied in a wide variety of contexts. The specific aspects and embodiments discussed herein are merely illustrative of ways to make and use the systems and methods disclosed herein and do not limit the scope of the disclosure. The systems and methods described herein may be used for treatment of process water from cementitious and/or fiber cement building articles and are described herein with reference to this application. However, it will be appreciated that the disclosure is not limited to this particular field of use.

Some embodiments have been described in connection with the accompanying drawings. The figures are drawn to scale, but such scale should not be limiting, since dimensions and proportions other than what are shown are contemplated and are within the scope of the disclosed inventions. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A method of treating process water from a cementitious article forming process, the method comprising:
receiving the process water from the cementitious article forming process, the process water comprising at least sulfate ions and calcium ions in solution;
reacting sodium aluminate with the sulfate ions and the calcium ions to form a solid precipitate primarily comprising ettringite, the solid precipitate suspended within the process water in slurry form;
clarifying the slurry to produce a clarified process water and a sludge that includes the solid precipitate; and
filtering the sludge to produce a liquid filtrate and a solid waste.

2. The method of claim 1, further comprising:
adjusting the pH of the liquid filtrate and the clarified process water; and
releasing the liquid filtrate and the clarified process water as effluent.

3. The method of claim 1, wherein the process water has an initial concentration of sulfate ions, and wherein the liquid filtrate and the clarified process water each have a concentration of sulfate ions lower than 50% of the initial concentration of sulfate ions.

4. The method of claim 1, wherein the solid precipitate comprises ettringite and calcium sulfate.

5. The method of claim 1, further comprising adding a flocculant to the process water before clarifying the process water and suspended precipitate.

6. The method of claim 1, further comprising, prior to the reacting, removing a permeate portion of the process water by reverse osmosis to produce a concentrate portion of the process water, and wherein the reacting comprises combining the sodium aluminate with the concentrate portion of the process water.

7. The method of claim 1, wherein the process water and the sodium aluminate solution are mixed for a reaction period of less than 20 minutes before the clarifying step.

8. The method of claim 1, wherein the sodium aluminate is not a limiting reagent of the reaction between the sodium aluminate, the sulfate ions, and the calcium ions.

9. The method of claim 1, wherein the sodium aluminate solution contains between 35% and 50% sodium aluminate.

10. The method of claim 9, wherein the sodium aluminate solution has a volume equal to between 0.1% and 0.3% of a volume of the process water.

11. A system for treating process water from a cementitious article forming process comprising:
a reaction tank in fluid communication with a process water flow path associated with the cementitious forming process, the reaction tank comprising an agitator;
a reagent tank containing a sodium aluminate solution, the reagent tank in fluid communication with the reaction tank;
metering equipment comprising at least one of a valve and a pump, the metering equipment configured to cause a predetermined volume of the sodium aluminate solution to flow from the reagent tank into the reaction tank;
a clarifier in fluid communication with the reaction tank; and
a filter in fluid communication with the clarifier;
wherein the process water flow path is configured to send, to the reaction tank, spent process water comprising sulfate ions and calcium ions produced by the cementitious article forming process;
wherein the sodium aluminate solution reacts with the sulfate ions and calcium ions to form a solid precipitate comprising ettringite; and
wherein the clarifier and the filter are configured to at least partially separate the solid precipitate from the process water to produce a volume of treated process water and a quantity of solid waste.

12. The system of claim 11, wherein the predetermined volume of the sodium aluminate solution is determined based at least in part on a concentration of sulfate or calcium ions in the spent process water.

13. The system of claim 11, wherein the predetermined volume of the sodium aluminate solution is between 0.1% and 0.3% of a volume of spent process water in the reaction tank.

14. The system of claim 11, wherein the sodium aluminate solution comprises between 35% and 50% sodium aluminate.

15. The system of claim 11, wherein the clarifier comprises a slant plate clarifier configured to output a clarified liquid arid a sludge.

16. The system of claim 15, wherein the filter is configured to receive the sludge and output a solid waste and a liquid filtrate.

17. The system of claim 11, further comprising at least one additional reaction tank in fluid communication with the process water flow path, the reagent tank, and the clarifier, wherein the metering equipment is configured to independently control a first flow of sodium aluminate into the reaction tank and a second flow of sodium aluminate into the at least one additional reaction tank.

18. A cementitious shaped article manufacturing system comprising:
a forming unit configured to form a cementitious shaped article, wherein the forming unit discharges spent process water containing at least sulfate ions and calcium ions;
a wastewater treatment unit configured to treat at least a portion of the spent process water by mixing the spent process water with sodium aluminate to form a solid precipitate, and removing the solid precipitate from the spent process water to produce a treated process water having a concentration of sulfate ions relatively lower than an initial concentration of sulfate ions in the spent process water; and
a discharge unit configured to adjust the pH of the treated process water.

19. The manufacturing system of claim 18, wherein the wastewater treatment unit comprises a clarifier and a filter for removing the solid precipitate from the spent process water.

20. The manufacturing system of claim 18, wherein the treated process water is substantially free of the solid precipitate.
